(19) United States
(12) Patent Application Publication
(10) Pub. No.: US 2021/0110352 A1
(43) Pub. Date: Apr. 15, 2021

(54) SCHEDULING CALENDAR EVENTS BASED ON SOCIAL ANALYTICS

(71) Applicant: INTERNATIONAL BUSINESS MACHINES CORPORATION, ARMONK, NY (US)

(72) Inventors: Jonathan D. Dunne, Dungarvan (IE); Nadiya Kochura, Bolton, MA (US); Alex Xingqi Casella, Cambridge, MA (US); Fang Lu, Billerica, MA (US)

(21) Appl. No.: 16/601,614

(22) Filed: Oct. 15, 2019

(51) Int. Cl. G06Q 10/10; G06Q 50/00; G06F 16/901

(52) U.S. Cl. CPC G06Q 10/1093; G06F 16/9024; G06Q 50/01

(57) ABSTRACT

The exemplary embodiments disclose a system and method, a computer program product, and a computer system for scheduling calendar events. The exemplary embodiments may include collecting data and identifying one or more factors from the collected data. The exemplary embodiments may additionally include scheduling the one or more calendar events by applying one or more models to the identified one or more factors.

### BACKGROUND

The exemplary embodiments relate generally to scheduling calendar events, and more particularly to scheduling calendar events based on spatial data and social analytics.

When scheduling events in a calendar, many factors must be taken into account, for example a time it takes to travel from the location of one event to the location of another. Doing so entails taking into account a method of transportation, a time of travel, a weather at the time of travel, and many other factors. In addition, who else is attending the event must also be considered, for example a punctuality or casualness of other attendees. Overall, there are many factors to consider when scheduling calendar events.

### SUMMARY

The exemplary embodiments disclose a system and method, a computer program product, and a computer system for scheduling calendar events. The exemplary embodiments may include collecting data and identifying one or more factors from the collected data. The exemplary embodiments may additionally include scheduling the one or more calendar events by applying one or more models to the identified one or more factors.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a calendar scheduling system 100, in accordance with the exemplary embodiments.

FIG. 2 depicts an exemplary flowchart illustrating the operations of a calendar scheduler 134 of the calendar scheduling system 100 in scheduling calendar events, in accordance with the exemplary embodiments.

FIG. 3 depicts an exemplary block diagram depicting the hardware components of the calendar scheduling system 100 of FIG. 1, in accordance with the exemplary embodiments.

FIG. 4 depicts a cloud computing environment, in accordance with the exemplary embodiments.

FIG. 5 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

When scheduling events in a calendar, many factors must be taken into account, for example a time it takes to travel from the location of one event to the location of another. Doing so entails taking into account a method of transportation, a time of travel, a weather at the time of travel, and many other factors. In addition, who else is attending the event must also be considered, for example a punctuality or casualness of other attendees. Overall, there are many factors to consider when scheduling calendar events.

Hence, an independent system is needed to address the problem. Example embodiments are directed to a method, computer program product, and system that will schedule calendar events in a user's calendar. In embodiments, machine learning and feedback loops may be used to construct a model that schedules calendar events in response to real-time environments. In other embodiments, data from user profiles, the internet, and social networks may be utilized. Use cases of embodiments described herein may relate to calendar scheduling for a user with meetings at several locations and with several other individuals. In general, it will be appreciated that embodiments described herein may relate to scheduling a user's calendar events within any environment.

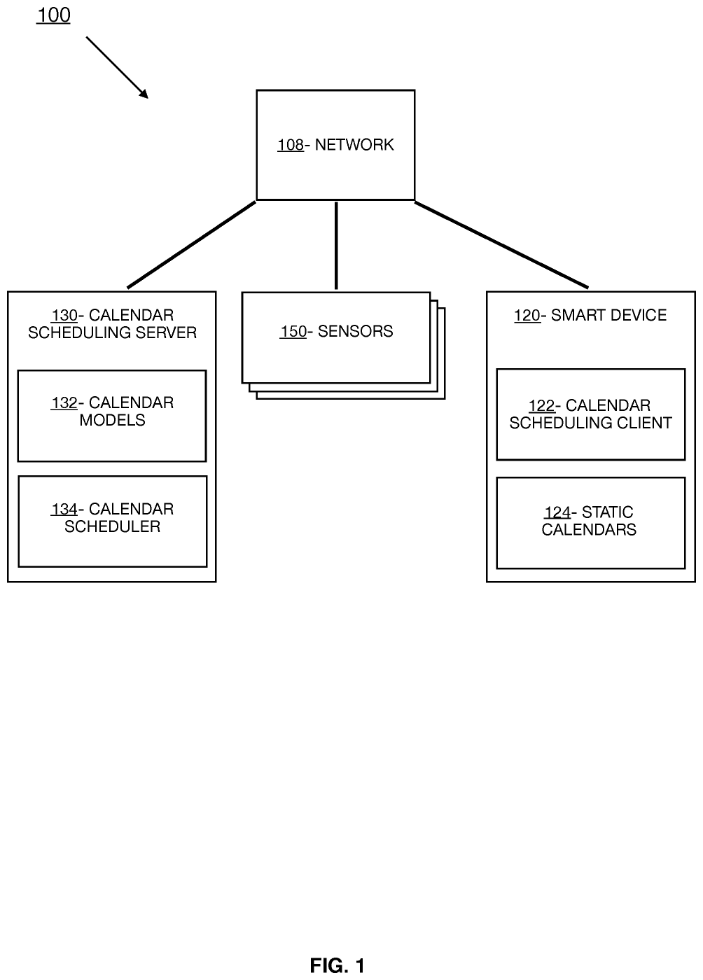

FIG. 1 depicts the calendar scheduling system 100, in accordance with the exemplary embodiments. According to the exemplary embodiments, the calendar scheduling system 100 may include a smart device 120, one or more sensors 150, and a calendar scheduling server 130, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the calendar scheduling system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

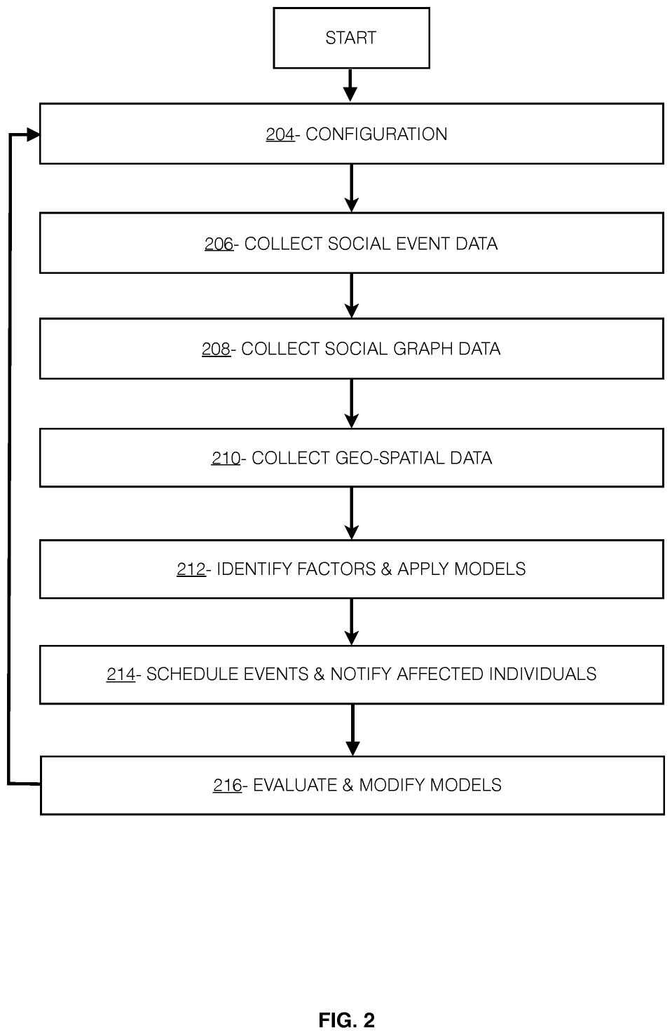

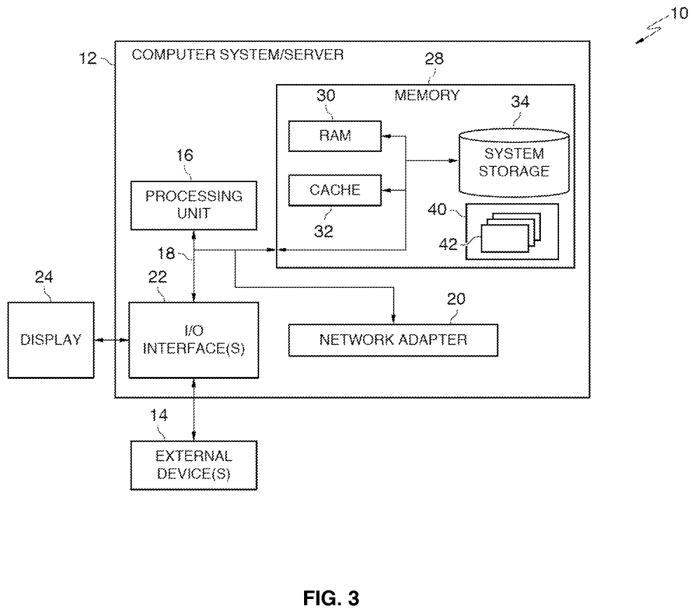

In the exemplary embodiments, the sensors 150 may be a camera, microphone, light sensor, infrared sensor, movement detection sensor, pressure detection sensor, thermometer, accelerometer, gyroscope, heart rate monitor, or other sensory hardware equipment. In embodiments, the sensors 150 may be incorporated within an environment in which the calendar scheduling system 100 is implemented. For example, the sensors 150 may be one or more cameras, badge readers, computing devices, etc. Moreover, data processing techniques may be implemented such that directional information of visual and audio data can be obtained based on signals received by each of the sensors 150, such as trilateration and triangulation. In embodiments, the sensors 150 may be integrated with smart devices, e.g., the smart device 120, within an environment implementing the calendar scheduling system 100. In such embodiments, the sensors 150 may communicate with the network 108 via other devices. The sensors 150 are described in greater detail with respect to FIGS. 2-3.

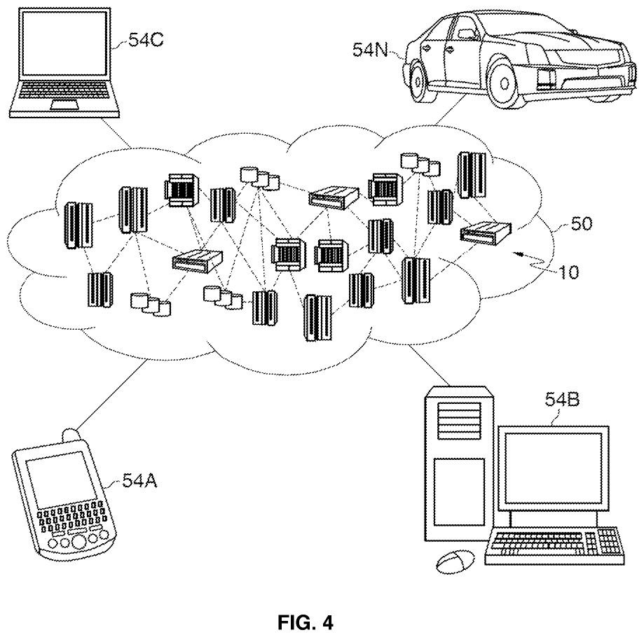

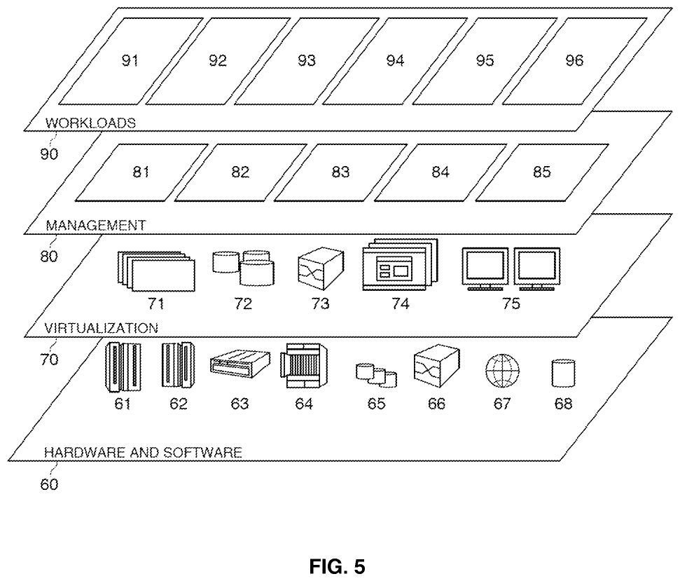

In the example embodiment, the smart device 120 includes a calendar scheduling client 122 and static calendars 124, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the smart device 120 is shown as a single device, in other embodiments, the smart device 120 may be comprised of a cluster or plurality of computing devices, in a modular manner, etc., working together or working independently. In addition to the components depicted by FIG. 3, the smart device 120 may further include an accelerometer, gyroscope, compass, barometer, thermometer, and other sensory equipment. The smart device 120 is described in greater detail as a hardware implementation with reference to FIG. 3, as part of a cloud implementation with reference to FIG. 4, and/or as utilizing functional abstraction layers for processing with reference to FIG. 5.

The calendar scheduling client 122 may be a software and/or hardware application capable of communicating with and providing a user interface for a user to interact with a server via the network 108. The calendar scheduling client 122 may act as a client in a client-server relationship. Moreover, in the example embodiment, the calendar scheduling client 122 may be capable of transferring data between the smart device 120 and other devices via the network 108. In embodiments, the calendar scheduler 134 utilizes various wired and wireless connection protocols for data transmission and exchange, including Bluetooth, 2.4 gHz and 5 gHz internet, near-field communication, Z-Wave, Zigbee, etc. The calendar scheduling client 122 is described in greater detail with respect to FIG. 2.

The static calendars 124 may be one or more calendars, schedules, itineraries, to-do's, plans, diagrams, outlines, or other representations describing one or more events. In addition to displaying a name, date, and time of an event, the static calendars 124 may additionally describe event titles, event descriptions, event start times, event durations, event end times, event locations, event participants, event participant characteristics, event weather, event dress code, etc. In embodiments, the calendar scheduler 134 may modify the static calendars 124 (e.g., add, remove, adjust events) when scheduling calendar events by incorporating information such as traffic patterns, weather patterns, anticipated delays, participants, etc. In the example embodiment, the static calendars 124 may be extracted from a user via reference to existing schedules/calendars, user profiles, work schedules, etc. The static calendars 124 may be updated manually, automatically, or both. These updates may occur periodically at set intervals, when modifications are detected, via sensory input, user input, etc.

In the exemplary embodiments, the calendar scheduling server 130 includes one or more calendar models 132 and a calendar scheduler 134. The calendar scheduling server 130 may act as a server in a client-server relationship with the calendar scheduling client 122 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the calendar scheduling server 130 is shown as a single device, in other embodiments, the calendar scheduling server 130 may be comprised of a cluster or plurality of computing devices, working together or working independently. The calendar scheduling server 130 is described in greater detail as a hardware implementation with reference to FIG. 3, as part of a cloud implementation with reference to FIG. 4, and/or as utilizing functional abstraction layers for processing with reference to FIG. 5.

The calendar models 132 may be one or more algorithms modelling a correlation between one or more factors and a scheduling of calendar events. In the example embodiment, the calendar models 132 may be generated using machine learning methods, such as neural networks, deep learning, hierarchical learning, Gaussian Mixture modelling, Hidden Markov modelling, and K-Means, K-Medoids, or Fuzzy C-Means learning, etc., and may model an effect of one or more factors on the scheduling of calendar events. In embodiments, such factors may be, for example, double-booked events, anticipated events, event participant characteristics, nearby occurrences, etc. The calendar models 132 may weight the factors based on an effect that the one or more factors have on the scheduling of calendar events. The calendar models 132 are described in greater detail with reference to FIG. 2.

The calendar scheduler 134 may be a software and/or hardware program capable of receiving a configuration. The calendar scheduler 134 may additionally collect and process social event data, social graph data, and geo-spatial data. Moreover, the calendar scheduler 134 may schedule events and notify calendar users. The calendar scheduler 134 is described in greater detail with reference to FIG. 2.

FIG. 2 depicts an exemplary flowchart illustrating the operations of a calendar scheduler 134 of the calendar scheduling system 100 in scheduling calendar events, in accordance with the exemplary embodiments.

The calendar scheduler 134 may receive a configuration (step 204). The calendar scheduler 134 may be configured by receiving a user registration and environment configuration. In the example embodiment, the configuration may be received by the calendar scheduler 134 via the calendar scheduling client 122 and the network 108. In embodiments, receiving a user registration may involve receiving demographic information such as a name, username, home location, a type of the smart device 120, a serial number of smart device 120, and the like. The calendar scheduler 134 may further receive information relating to the profession of a user, such as a job title/role, responsibilities, employer, site locations, etc. Moreover, the calendar scheduler 134 may further receive any other information relevant to scheduling user calendar events, such as information regarding extracurricular activities, exercise plans, hobbies, etc. In embodiments, the calendar scheduler 134 may further receive a reference to a social or professional network corresponding to a user.

The calendar scheduler 134 may further receive an environment configuration during the configuration (step 204 continued). The environment configuration may include receiving a configuration of the smart device 120, for example a smart phone, as well as other devices such as vehicles, laptops, glasses, etc. In addition, the environment configuration may include receiving a configuration of the one or more sensors 150. For example, the environment configuration for a home may include configuring one or more smart devices, such as a smart speaker, camera, or automatic door opener, while the environment configuration for a work may include configuring one or more badge readers, operating systems, or security cameras.

To further illustrate the operations of the calendar scheduler 134, reference is now made to an illustrative example where a user uploads a user registration with his name and smart phone serial number, and an environment configuration indicating the locations of security cameras outside his garage at home and a badge reader at his office building.

The calendar scheduler 134 may collect social event data (step 206). Social event data may consist of the times, locations, and participants of past, present, and future events. In order to gather this social event data, the calendar scheduler 134 may access the static calendars 124 of a user via a device corresponding to the user, company/organization database, user input, the internet, etc. and extract event data from the static calendars 124. In embodiments, the calendar scheduler 134 may extract data relating to a name, time, place, and any other available event information. When not readily available from the static calendars 124, the calendar scheduler 134 may cross-reference event information with other sources, such as user registration information, environment configuration information, databases, directories, maps, the internet, and any other available resources. For example, the calendar scheduler 134 may access the calendar of a user via reference to a static calendar 124 maintained on the smart device 120 of the user, then cross-reference event information within the static calendar 124 with the user profile or online resources to determine a location of a scheduled calendar event. In addition to extracting data relating to a name, time, and place of an event, the calendar scheduler 134 may additionally extract event data such as participants from the static calendars 124 (described in greater detail forthcoming).

With reference again to the previously introduced example, the calendar scheduler 134 extracts the user's static calendars 124 from their smart phone that includes a work meeting at 9 am, a workout with a gym partner planned for 6 pm, and a dinner reservation for 8 pm. The calendar scheduler 134 references the user profile to determine the location of a home, work, and gym of the user, while referencing the internet to determine the location of the listed restaurant.

The calendar scheduler 134 may collect a user's social graph data (step 208). The calendar scheduler 134 may gather the identity of individuals in the user's personal, professional, or other networks, and other information about these individuals, including relationship to the user, timeliness/punctuality, reliability, casualness, and other tendencies. In order to collect this data, the calendar scheduler 134 may reference participant user registrations, past interactions with the participants, social networks, the internet, etc. For example, the calendar scheduler 134 may reference registrations of and previous interactions with participants to determine a punctuality, reliability, casualness, etc. of a participant. In addition, the calendar scheduler 134 may extract data from sources such as the internet and the social networks of both the user and individuals within the user's networks, and may include social network data, such as a status, location, etc. as well as audio, video, and sensor data of an individual. For example, the calendar scheduler 134 may reference social media networks to gather information about a user's punctuality by comparing a time that the user checks in to various locations to times of scheduled events. Alternatively, the calendar scheduler 134 may determine a punctuality of a participant by comparing a time at which a participant badges into work to a work start time, or comparing log-in or security camera information of a participant entering a gym to a time a gym class starts. Additionally, the calendar scheduler 134 may determine an average punctuality of a participant based on determining whether a participant frequently cancels or reschedules an event. In embodiments, the calendar scheduler 134 may further determine a casualness of participants to an event which, in embodiments, may be indicative of an importance of punctuality to the user. For example, the calendar scheduler 134 may determine that an event is scheduled during a typical work hour, and may further reference a work directory to determine that participants to an event include a manager. Based on the manager's presence, the calendar scheduler 134 may determine a low casualness of the event and prioritize getting to the event early. Alternatively, if the calendar scheduler 134 determines that an event is after work and with friends at a local restaurant, the calendar scheduler 134 may determine that a user may be late due to high casualness.

With reference again to the previously introduced example, the calendar scheduler 134 references a work directory indicating that the user's work meeting at 9 am is scheduled with the user's manager. Moreover, the calendar scheduler 134 references badge reader data to determine that the manager is generally on-site by 9 am. In addition, the calendar scheduler 134 references social network status updates of the gym partner of the user to determine that the gym partner is routinely 15 minutes late. Lastly, the calendar scheduler 134 references a social network to determine that the user's dinner at 8 pm is with a long-time friend.

The calendar scheduler 134 may collect geo-spatial data (step 210). Geo-spatial data may be collected via the smart device 120, the one or more sensors 150, etc., and consist of a user's position, event locations, and any other relevant data pertaining to either, such as surrounding weather patterns, traffic patterns, emergency situations, gatherings of crowds, etc. In embodiments, a user's smart device 120 may utilize the Global Positioning System (GPS) or another method to identify where the user is located relative to their environment and particular surrounding markers, as well as distances between two consecutive events or between the user and the location of the user's next event. For example, the calendar scheduler 134 may utilize user registration information to determine a home and work location of a user, and the GPS in a user's smartphone to locate the user's current position. The calendar scheduler 134 may use this position to collect the distance between the user's current location and the location of the user's next event. The calendar scheduler 134 may also collect past and current weather data, news data, and various other types of data via network 108. For example, the calendar scheduler 134 may reference one or more traffic cameras to determine traffic between two events the user plans on attending. Alternatively, the calendar scheduler 134 may reference data of a previous snowstorm that is similar to a predicted snowstorm in order to estimate delays. Likewise, if a parade has historically taken place on July 4^{th} every year, the calendar scheduler 134 may collect information pertaining to the parade's past effect on traffic patterns. The calendar scheduler 134 may gather past and current trends to anticipate nearby occurrences such as traffic patterns, route closures, natural disasters, gatherings of crowds, and any other occurrences that may affect a user's schedule. In embodiments, the calendar scheduler 134 may utilize historical user data to determine geo-spatial considerations, such as previous travel times as recorded by GPS, vehicles, badge times, cameras, log-in/out times, status updates, etc.

With reference again to the previously introduced example, the calendar scheduler 134 retrieves home and work location information from the received user registration, and determines a location of the dinner reservation and gym by cross-referencing a name of the restaurant with online resources. In addition, the calendar scheduler 134 collects traffic camera data between home and work locations from 8 am-9 am, between work and gym locations from 5 pm-6 pm, and between gym and dinner reservation locations from 7 pm-8 pm. Lastly, the calendar scheduler 134 extracts weather data forecasting snow around dinner, and references historical delays based on the amount of snow and time.

The calendar scheduler 134 may process social event data, social graph data, and geo-spatial data to identify factors such as double-booked events, anticipated events, event participant characteristics, nearby occurrences, and the like, which may result in the scheduling or rescheduling of one or more calendar events (step 212). The calendar scheduler 134 may identify double-booked events by processing social event data to determine that a user has scheduled more than one event at more than one location at the same time. The calendar scheduler 134 may address double-booked events by rescheduling or cancelling one of the double-booked events. For example, the calendar scheduler 134 may determine that a user has two events scheduled at 9 am on a Friday morning in the user's static calendars 124 and identify a double-booked event. The calendar scheduler 134 may then address this double-booked event by identifying free time of the one or more participants and rescheduling during the free time. In embodiments, the calendar scheduler 134 may first notify and/or require consent of one, a majority, or all participants before rescheduling.

In addition to processing social event data to identify double-booked events, the calendar scheduler 134 may also process social event data and social graph data to identify anticipated events (step 212 continued). The calendar scheduler 134 may identify anticipated events by determining that a user has historically scheduled an event according to a certain pattern and predict that the user may wish to schedule a similar event at a similar future time. For example, the calendar scheduler 134 may determine that a user had scheduled a movie night with his family at Bpm on the past ten consecutive Saturday nights. The calendar scheduler 134 may anticipate a movie night for the coming Saturday night at 8 pm, even though the user's calendar does not show a movie night scheduled for the coming Saturday night. The calendar scheduler 134 may address an anticipated event by tentatively scheduling the anticipated event or prompting the user to consider the anticipated event. In addition to identifying an anticipated event from collected social event data, the calendar scheduler 134 may also identify an anticipated event by identifying a gathering of individuals in a user's social graph. For example, the calendar scheduler 134 may find a social media post on the internet or an email message sent to the user declaring that several of a user's family members are gathering together near a user. The calendar scheduler 134 may address a nearby anticipated event by scheduling a tentative event. For example, the calendar scheduler 134 may assume that the user may wish to join his family members, and therefore may schedule a tentative event for him to do so or prompt him to consider the event.

In addition to processing social event data and social graph data to identify anticipated events, the calendar scheduler 134 may also process social event data and social graph data to identify event participant characteristics (step 212 continued). The calendar scheduler 134 may identify event participant characteristics by analyzing information about event participants such as name, title, company name, email address, phone number, profile photo, etc. from the user's static calendars 124, from information uploaded in the configuration step, from the internet, and the like. The calendar scheduler 134 may use this information to identify an individual as important, unimportant, a business participant, a casual participant, historically early, historically late, and the like. The calendar scheduler 134 may also identify event participant characteristics by utilizing the one or more sensors 150 to identify an individual's punctuality. The calendar scheduler 134 may detect audio, video, pressure, temperature, etc. data along with a timestamp via the one or more sensors 150 in an environment to locate the user at a given time. For example, the calendar scheduler 134 may analyze video footage of an individual arriving at the office for an event ten minutes late to determine that the individual is historically late. The calendar scheduler 134 may address event participant characteristics by modifying a user's event start time, departure time, arrival time, or the like. For example, the calendar scheduler 134 may determine that an event is scheduled with a user's manager, who is an important and low casualness event participant. The calendar scheduler 134 may then adjust the user's calendar to reflect an earlier than normal departure to make it less likely that the user arrives to the event late. The calendar scheduler 134 may also notice that an event is scheduled with a user's friend who has arrived between five and ten minutes late to every event with the user over the past two years. The calendar scheduler 134 may then adjust the user's calendar to reflect a later than normal departure to make it less likely that the user arrives to the event early.

In addition to processing social event data and social graph data to identify event participant characteristics, the calendar scheduler 134 may also process geo-spatial data to identify nearby occurrences (step 212 continued). The calendar scheduler 134 may identify nearby occurrences by locating a user and their calendar events, and noticing occurrences near the user's location such as traffic patterns, weather patterns, unanticipated activities, etc. from searching the internet. The calendar scheduler 134 may locate the user by utilizing GPS, the one or more sensors 150, etc. For example, if a microphone in a user's garage collects audio above a threshold decibel level, the calendar scheduler 134 may determine that the user is in the garage. If a video camera in a user's office space detects an object moving, the calendar scheduler 134 may determine that the user is in the office space. The calendar scheduler 134 may adjust a user's calendar to address nearby occurrences such as traffic patterns, weather patterns, unanticipated activities, and the like by instructing the user to depart earlier or later to events or rescheduling events. The calendar scheduler 134 may identify traffic patterns by identifying traffic congestion on certain routes, closed streets, delayed planes, trains, busses, etc. For example, the calendar scheduler 134 may determine that a lane on a highway is closed, causing an additional fifteen minutes of traffic, and adjust the calendar of the user to leave fifteen minutes earlier. In embodiments, the calendar scheduler 134 may be integrated with GPS programs and incorporate the time of different routes based on traffic. For example, if the calendar scheduler 134 determines that a street is blocked off, and the GPS program determines that the next best transportation route involves taking a side street that will increase the user's travel duration by five minutes, the calendar scheduler 134 may instruct the user to leave for their event five minutes earlier than otherwise planned. The calendar scheduler 134 may identify weather patterns by analyzing rain and snow forecasts, temperature predictions, natural disaster likelihood indicators, and the like. For example, the calendar scheduler 134 may identify that there is a 95% chance of snow near an event and identify that snow will likely cause a ten-minute delay in commuting to the event based on a comparison to historical data. The calendar scheduler 134 may then address this by instructing the user to leave for the event ten minutes earlier than otherwise planned. Unanticipated activities may include parades, celebrations, festivals, concerts, and the like. For example, the calendar scheduler 134 may identify a parade taking place near a user's scheduled event and may address it by instructing the user to depart for the scheduled event five minutes earlier than otherwise planned.

In addition to processing the social event data, social graph data, and geo-spatial data individually, the calendar scheduler 134 may process the data in combination/bulk (step 212 continued). The calendar scheduler 134 may treat the combination of more than one factor indicating the same scheduling of a calendar event as a stronger indication of that scheduling of a calendar event being necessary than one of the factors individually. Similarly, the calendar scheduler 134 may treat the combination of more than one factor indicating two conflicting schedules of a calendar event as a weaker indication of either of those schedules of a calendar event than one of the factors individually.

In the example embodiment, the calendar scheduler 134 may utilize the processed factors in order to schedule or reschedule calendar events (step 212 continued). In embodiments, this may involve the calendar scheduler 134 identifying factors and associating them with the scheduling of calendar events. As previously described, such factors may include double-booked events, anticipated events, event participant characteristics, nearby occurrences, etc. In some embodiments, each of the factors may be weighted by the calendar models 132 such that factors shown to have a greater association with the scheduling of calendar events are weighted greater than those factors that are not. Such weighting may be accomplished through machine learning techniques such as neural networks, hierarchical learning, or regularization. Such techniques may assign weights to the factors or combination of factors as discussed earlier, that are modified and tweaked through use of a feedback loop indicative of whether a calendar event was properly scheduled and which factors were most relied upon in the determination, etc. The feedback loop is described in greater detail below. In applying the model, the calendar scheduler 134 may schedule, reschedule, indicate to users a relaxed start time, etc., based on the aforementioned factors. Such modifications may include scheduling an event, rescheduling an event, scheduling/rescheduling a planned departure time for an event, canceling an event, notifying one or more participants of tardiness, and the like. For example, if the calendar scheduler 134 determines that an event is business related with coworkers who are routinely punctual in an office across town during rush hour, the calendar scheduler 134 may adjust a calendar of the user to reschedule the meeting, to leave early, or to indicate that the user must be on time for that event. Alternatively, the calendar scheduler 134 may cancel or reschedule an event if the factors indicate that traffic to and casualness of an event is high. In general, the calendar scheduler 134 may consider any social event data, social graph data, and geo-spatial data when scheduling or rescheduling user calendar events.

With reference again to the previously introduced example, the calendar scheduler 134 processes social event data, social graph data, and geo-spatial data pertaining to the user's schedule to determine that the user should depart for his work meeting twenty minutes earlier than otherwise planned due to traffic and the importance of the meeting with their manager at 9 am. In addition, the calendar scheduler 134 may reschedule the workout of the user to 6:15 PM based on a gym partner consistently running behind schedule. Lastly, the calendar scheduler 134 may notify the user and participants of the 8 pm dinner reservation that the user may be ten minutes late due to the casualness of the dinner and the forecasted snowstorm.

The calendar scheduler 134 may schedule/reschedule calendar events and notify affected parties of the scheduling of calendar events (step 214). The calendar scheduler 134 may display the updated calendar that reflects all implemented modifications to the scheduling of calendar events on a user's smart device 120, such as their smart phone, smart tablet, augmented reality glasses, smart watch, etc. The display may incorporate the user's user interface settings and preferences. In other embodiments, the calendar scheduler 134 may generate an optimized calendar to replace a user's static calendars 124. In some embodiments, a user may have submitted user preferences such that the user receives notifications of any modifications to their static calendars 124, rather than receiving the updated or generated calendar displayed on their smart device 120. For example, the calendar scheduler 134 may use colors to indicate events of greater importance with, for example, red colored events being those that a user cannot be late to or miss. The calendar scheduler 134 may also notify all affected individuals of any changes made by the calendar scheduler 134. If an event was cancelled or rescheduled, all individuals in the user's social graph who are affected by the event's modification may be notified of the modification. Notification of modifications may be in the form of a message sent on behalf of the user to each affected individual on any voice or video message sending platform, or any message sending platform such as email, text message, or any social media platforms. The notification may appear on each affected individual's smart device 120 in the form of an alert or display. The form or manner in which a notification or message is distributed may be customizable by the user or by each individual receiving said notification or message. Notifications of event modifications may be collected, analyzed, and applied to an individual's calendar in the event that an affected individual happens to also be utilizing the same or similar calendar scheduling system 100.

With reference again to the previously introduced example, the calendar scheduler 134 updates the user's calendar to reflect leaving for work twenty minutes early and starting the workout at 6:15 PM. In addition, the calendar scheduler 134 notifies the long-time friend that the user may be ten minutes late for dinner.

The calendar scheduler 134 may evaluate and modify its models (step 216). In the example embodiment, the calendar scheduler 134 may verify whether the user attended or did not attend various events in order to provide a feedback loop providing the capability to modify and tweak models and weighting values utilized in scheduling calendar events. In embodiments, the feedback loop may simply provide a means for a user to indicate whether a calendar positively affected their schedule. For example, the calendar scheduler 134 may prompt a user to select an option indicative of whether the calendar helped their schedule or whether the user arrived at an event on time. The option may comprise a toggle switch, button, slider, etc. that may be selected by the user manually by hand using a button/touchscreen/etc., by voice, by eye movement, and the like. In other embodiments, the calendar scheduler 134 may utilize one or more sensors 150 which may be located on a smart device 120 or may be located independent of a smart device 120 to determine whether a user attended an event. In these embodiments, the sensors 150 may also determine whether the optimized calendar positively affected the user's schedule by determining whether the user was late or early for any events, rushing to or from any events, etc. Examples of sensors 150 that may be utilized for this feedback are cameras, microphones, light sensors, infrared sensors, movement detection sensors, pressure detection sensors, thermometers, accelerometers, gyroscopes, and heart rate monitors. The calendar scheduler 134 may further reference other participants to evaluate model values for participant punctuality, importance, etc.

With reference again to the previously introduced example, the calendar scheduler 134 references a GPS of the user to determine a time at which the user arrived at work, the gym, and the dinner reservation in order to evaluate models. In some embodiments, the calendar scheduler 134 may additionally prompt the user to indicate whether he was satisfied with the scheduling of the last event after each and every event that the user attends.

FIG. 3 depicts a block diagram of devices within the calendar scheduling system 100 of FIG. 1, in accordance with the exemplary embodiments. It should be appreciated that FIG. 3 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and calendar event scheduling 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for scheduling one or more calendar events, the method comprising:
collecting data selected from a group comprising social event data, social graph data, and geo-spatial data;
identifying one or more factors from the collected data; and
scheduling the one or more calendar events based on applying one or more models to the identified one or more factors.

2. The method of claim 1, wherein the one or more models correlate the one or more factors with the scheduling of a calendar event.

3. The method of claim 1, further comprising:
receiving feedback indicative of whether the user was on time to the one or more calendar events; and
adjusting the model based on the received feedback.

4. The method of claim 1, wherein the social event data includes data selected from a group comprising name, username, home locations, job roles, responsibilities, employers, site locations, extracurricular activities, exercise plans, and hobbies.

5. The method of claim 1, wherein the social graph data includes data selected from a group comprising relationship to the user, timeliness, casualness, and reliability.

6. The method of claim 1, wherein the geo-spatial data includes data selected from a group comprising weather patterns, traffic patterns, natural disasters, emergency situations, and gatherings of crowds.

7. The method of claim 1, wherein the one or more factors include factors selected from a group comprising double-booked events, anticipated events, event participant characteristics, and nearby occurrences.

8. A computer program product for scheduling one or more calendar events, the computer program product comprising:
one or more non-transitory computer-readable storage media and program instructions stored on the one or more non-transitory computer-readable storage media capable of performing a method, the method comprising:
collecting data selected from a group comprising social event data, social graph data, and geo-spatial data;
identifying one or more factors from the collected data; and
scheduling the one or more calendar events based on applying one or more models to the identified one or more factors.

9. The computer program product of claim 8, wherein the one or more models correlate the one or more factors with the scheduling of a calendar event.

10. The computer program product of claim 8, further comprising:
receiving feedback indicative of whether the user was on time to the one or more calendar events; and
adjusting the model based on the received feedback.

11. The computer program product of claim 8, wherein the social event data includes data selected from a group comprising name, username, home locations, job roles, responsibilities, employers, site locations, extracurricular activities, exercise plans, and hobbies.

12. The computer program product of claim 8, wherein the social graph data includes data selected from a group comprising relationship to the user, timeliness, casualness, and reliability.

13. The computer program product of claim 8, wherein the geo-spatial data includes data selected from a group comprising weather patterns, traffic patterns, natural disasters, emergency situations, and gatherings of crowds.

14. The computer program product of claim 8, wherein the one or more factors include factors selected from a group comprising double-booked events, anticipated events, event participant characteristics, and nearby occurrences.

15. A computer system for scheduling one or more calendar events, the computer system comprising:
one or more computer processors, one or more computer-readable storage media, and program instructions stored on the one or more of the computer-readable storage media for execution by at least one of the one or more processors capable of performing a method, the method comprising:
collecting data selected from a group comprising social event data, social graph data, and geo-spatial data;
identifying one or more factors from the collected data; and
scheduling the one or more calendar events based on applying one or more models to the identified one or more factors.

16. The computer system of claim 15, wherein the one or more models correlate the one or more factors with the scheduling of a calendar event.

17. The computer system of claim 15, further comprising:
receiving feedback indicative of whether the user was on time to the one or more calendar events; and
adjusting the model based on the received feedback.

18. The computer system of claim 15, wherein the social event data includes data selected from a group comprising name, username, home locations, job roles, responsibilities, employers, site locations, extracurricular activities, exercise plans, and hobbies.

19. The computer system of claim 15, wherein the social graph data includes data selected from a group comprising relationship to the user, timeliness, casualness, and reliability.

20. The computer system of claim 15, wherein the geo-spatial data includes data selected from a group comprising weather patterns, traffic patterns, natural disasters, emergency situations, and gatherings of crowds.
